(19) United States
(12) Patent Application Publication
(10) Pub. No.: US 2026/0189904 A1
(43) Pub. Date: Jul. 2, 2026

(54) WIRELESS TRANSMISSION DEVICE AND SYSTEM FOR AUTHENTICATING SUCH A DEVICE

(71) Applicants: Koninklijke KPN N.V., Rotterdam (NL); Nederlandse Organisatie Voor Toegepast-Natuurwetenschappelijk Onderzoek TNO, s-Gravenhage (NL)

(72) Inventors: Antonius Hendrikus Johannes Norp, The Hague (NL); Jayaprakash Manganahalli, Rijswijk (NL)

(21) Appl. No.: 19/130,821

(22) PCT Filed: Nov. 23, 2023
(86) PCT No.: PCT/EP2023/082782

§ 371 Date: May 16, 2025

(30) Foreign Application Priority Data
Dec. 15, 2022 (EP) 22214011

(51) Int. Cl. H04W 12/06; H04W 12/037; H04W 12/041

(52) U.S. Cl. CPC H04W 12/06; H04W 12/037; H04W 12/041

(57) ABSTRACT

The disclosure pertains to a wireless transmission device and an authentication system. The wireless transmission device is configured to perform a transmission to a network, the network comprising at least a wireless receiving node configured to wirelessly receive the transmission and a further network system behind the wireless receiving node in the network. The transmission is configured to be authenticated in the network without requiring a bidirectional connection between the wireless transmission device and the further network node in the network. Therefore, the wireless transmission device may contain a long-term key, one or more nonces and a device identifier. The wireless transmission device may be configured to generate a derived key from the long-term key and a nonce of the one or more nonces. The transmission may consist of a single message containing at least the device identifier encrypted with the derived key for authentication in the network.

### TECHNICAL FIELD

The present disclosure relates to a wireless transmission device and an authentication system. In particular, the disclosure relates to a wireless transmission device configured to perform a transmission to a network comprising at least a wireless receiving node configured to wirelessly receive the transmission and a further network system behind the wireless receiving node in the network. The disclosure further relates to a network system configured to perform a transmission to a wireless device.

### BACKGROUND

In order for a conventional user equipment, UE, to send a data transmission to a telecommunications network, the network will normally first authenticate the UE and establish a secure bidirectional end-to-end connection or channel towards a node, for example in the core network, behind the wireless receiving node. Subsequently, the UE can transmit messages securely to the network. 3GPP TS 33.501 specifies such an authentication procedure between a UE and a 5G Core network, 5GC.

### SUMMARY

The inventors have realized that new use cases come into existence wherein wireless transmission devices are not able to make use of conventional authentication and security procedures to send messages securely.

For example, 3GPP recently issued a study on ambient power-enabled Internet of Things, IoT, in Technical Recommendation 3GPP TR 22.840. The document discloses use cases and requirements for ambient power-enabled IoT devices, hereinafter also referred to as ambient IoT devices, being battery-less devices with limited energy storage capability (a capacitor may be included) wherein the energy is provided through the harvesting of radio waves, light, motion, heat or any other power source that could be suitable. The study assumes that a 5G network may be used to send a discovery signal to discover ambient IoT devices within an area and that the ambient IoT device establishes communication with the 5G network to send an identity and for example goods information to the 5G network for further processing in a management platform. However, since such ambient IoT devices harvest power exclusively from external stimuli, such ambient IoT device will have difficulty to perform lengthy procedures to authenticate and establish a bidirectional association to send messages.

Likewise, a UE may be connected to a telecommunications network via satellites serving as quasi base stations. If such a UE is required to authenticate using conventional methods and establish a secure association to send messages, a bidirectional link to the telecommunications system is required that might not always be available via the satellites providing a hop-by-hop connection.

Yet another use case where conventional authentication may be problematic is in the field of Vehicle-to-Everything (V2X) type communications, wherein high mobility may result in intermittent connections instead of stable bidirectional connections to perform authentication and have a secure association.

Further use cases have been envisioned, such as the use of a relay (for example, a gateway device in a house or business environment) reachable by the wireless transmission device but not always connected to the network. Also in this case it is desired that the wireless transmission device can transmit small messages without first having to wait for a (re)connection of the relay to the network for authentication and a security association.

It is to be appreciated that other considerations may apply for using the fast authentication message as disclosed herein. One example would be that the amount of data to be transmitted is small so that it would be inefficient to perform an extended authentication procedure and establish a security context. Such procedure would result in a higher overhead than justified for actual data to be exchanged between the wireless device and network.

In order to enable authenticated transmissions in such cases, the inventors have come up with a wireless transmission device that can transmit an authenticatable message within a short time that does not require a bidirectional connection as required in conventional authentication and/or security association procedures.

To that end, a wireless transmission device is disclosed that is configured to perform a transmission to a network, the network comprising at least a wireless receiving node configured to wirelessly receive the transmission and a further network system behind the wireless receiving node in the network. The transmission is configured to be authenticated in the network without requiring a bidirectional connection between the wireless transmission device and the further network node in the network. Therefore, the wireless transmission device may contain a long-term key, one or more nonces and a device identifier. The wireless transmission device may be configured to generate a derived key from the long-term key and a nonce of the one or more nonces. The transmission may consist of a single message containing at least the device identifier encrypted with the derived key for authentication in the network. The further network system, for example an authentication system therein, may have access to the long-term key of the wireless transmission device and may have access to the nonce used by the wireless transmission device.

Another aspect of the disclosure involves an authentication system in a network having access to a long-term key of a wireless transmission device and a nonce used by the wireless transmission device to derive a derived key. The authentication system is configured to receive a single message from the wireless transmission device containing a device identifier of the wireless transmission device encrypted with the derived key. The authentication system is further configured to access the long-term key and nonce based on a device identifier of the wireless transmission device accessible by the authentication system to derive the derived key and to authenticate the wireless transmission device by decrypting the encrypted device identifier from the single message using the derived key. The authentication system may determine that the device identifier of the wireless transmission device is authentic for example by comparing the decrypted device identifier and the device identifier corresponding to the long-term key. The authentication system does not require a bidirectional connection with the wireless transmission device.

The wireless transmission device generates, and the authentication system processes, a single message containing sufficient information to authenticate the wireless transmission device. The single message does not require a conventional authentication and association procedure. Such conventional procedures require multiple, bidirectional steps and are therefore inherently lengthy. The wireless transmission device and authentication system provide for a lightweight authentication solution for situations wherein the wireless transmission device is power limited severely or where the possibility to establish a bidirectional connection between the wireless transmission device and the authentication system is not guaranteed.

It should be appreciated that the wireless transmission device is defined to contain at least one nonce, i.e. a random number used only once in a cryptographic communication. In one embodiment, the wireless transmission device may contain a generator to generate a nonce based on an input parameter, so that the device contains the nonce when needed to derive the derived key. In another embodiment, the wireless transmission device stores one or more nonces for this purpose in a storage part of the device. The network, such as the authentication system therein may be configured to derive the nonce based on an identical input parameter as used by the nonce generator of a wireless transmission device, or the wireless transmission device may transmit the nonce or the input parameter to the authentication system, for example in the single message or in a previous single message.

It should be noted that more than one nonce may be used for or in the transmission of the single message. A further nonce may, for example, be used for a further encryption function to encrypt contents of the single message.

It should be appreciated that the wireless receiving node provides the radio interface for wireless communication directly with the wireless transmission device. The further network node is a node behind the wireless receiving node, that may have a wireless or wired connection to the wireless receiving node, such as base station, a satellite, a system performing a control plane function in a 5G or further generation network, such as an Access and Mobility Function, AMF, an Authentication Server function, AUSF, a Unified Data Management, UDM, function, or a dedicated authentication function in a telecommunications network.

It should be appreciated that a Radio Resource Control, RRC, connection may exist or be established between the wireless transmission device and the wireless receiving node prior to sending the single message.

The single message contains the device identifier in encrypted form to enable authentication of the wireless transmission device. The device identifier may also be of interest as data beyond the purpose of authentication, for example when the mere presence of the device is to be verified. However, in one embodiment, the single message may contain a further, small amount of data. Such data may, without limitation, comprise sensor data gathered by sensors of or connected to the wireless transmission device, data representing a state in or of the wireless transmission device or be data stored in the device. The data may be encrypted with the derived key to protect the data during transmission to the wireless receiving node. The data may, in addition or alternatively, be encrypted with a client key, available to the wireless transmission device and a client system, to protect the data in the telecommunications network until the data arrives at the client system.

In one embodiment, the single message of the wireless transmission device may further contain information representing an identifier associated with the wireless transmission device. This information may be the device identifier also used for authentication, a temporary identifier or some other form of the device identifier. The authentication system may use the information representing the device identifier to access the long-term key and/or nonce used for deriving the derived key. It should be appreciated that the authentication system may, alternatively or as a further check, also access the long-term key and nonce in another manner. One way the network may know the device is e.g. that the single message comes in via a particular channel or link (e.g. on lower layer protocol, such as RRC signaling), which the network can associate with a device identifier. The wireless receiving node may forward part or all of the single message further into the network, such as to the authentication system, for authentication.

In one embodiment, the single message of the wireless transmission device may further contain information representing the nonce of the one or more nonces, used to generate the derived key. In this manner, the authentication system may determine the nonce used for deriving the derived key from the single message. It should be appreciated that the information representing the nonce may comprise the nonce itself, an identifier of the nonce, an input parameter used to generate the nonce, or some other form of the nonce.

As mentioned above, one particular use case wherein fast authentication is highly preferred, involves ambient IoT devices. In one embodiment, the wireless transmission device comprises such an ambient IoT device, being a battery-less device receiving operating power from the environment, such as from radio signals, light, heat, motion, etc. An example of an ambient IoT device is a device as disclosed in 3GPP TR 22.840. An ambient IoT device may be a simple battery-less device that can be attached to a product, for example as a sticker.

In one embodiment, the wireless transmission device may comprise at least a power harvesting part configured to harvest power from a power signal, such as a radio signal, and a communication part configured for being powered by the power signal and for wireless transmission of the single message to the wireless receiving node during powering by the power signal.

In one embodiment, the power may be harvested from a single power pulse of limited duration. Because of the limited time period during which power is available, such devices benefit from fast authentication in the network to which the single message is transmitted.

In one embodiment, the wireless transmission device may comprise a receiver to receive a signal representing an acknowledgment of successful authentication of the wireless transmission device or successful receipt of the single message in the network. Such an acknowledgement may be received when a connection to the wireless transmission device is, possibly temporarily, available and the wireless transmission device is powered. The device may use the acknowledgement, for example, as an indication that data may be discarded from its storage.

In one embodiment, the wireless transmission device may comprise a receiver to receive new nonce information. In this manner, the wireless transmission device may update its nonce or set of nonces used to derive the derived key. The new nonce information may come from the network and may serve to make sure that both the wireless transmission device and network use the same nonce for deriving the derived key.

Optionally, the wireless transmission device may interpret the new nonce information as acknowledgement of successful authentication of the wireless transmission device in the network or successful receipt of the single message.

It should be appreciated that the acknowledgement signal and/or the new nonce information may be transmitted to and received by the wireless transmission device at a later point in time than immediately in response to the transmission of the single message. This transmission may, for example, take place when a connection from the network to the wireless transmission device exists.

More generally, the receiver of the wireless transmission device may be configured to receive further data or instructions from the network. For a wireless transmission device that harvests power from the environment, it is not generally known in the network when communication to this device is possible. Hence, responding to the single message from the wireless transmission device may be a good option for an attempt to transmit further data, such as acknowledgements, nonce information, deactivation messages, update information, etc, to be received, processed and, possibly, stored in the wireless transmission device.

In one embodiment, the wireless transmission device may be configured to harvest power from at least one of the data and instructions received from the network, such as signals representing an acknowledgement of successful authentication or successful transmission of the single message and the new nonce information. The authentication system may be configured to enable transmission of at least one of these with sufficient power to power the wireless transmission device from which the single message was authenticated. This may increase the chance that an ambient IoT device, for example, is enabled to process the data and/or instructions.

In one embodiment, the wireless transmission device may comprise a storing part storing data. The wireless transmission device may be configured to transmit multiple single messages, each single message comprising at least the device identifier encrypted with the derived key and the data or part of the data stored in the storing part. The embodiment facilitates sending a larger amount of data as multiple single messages, each of which can be authenticated individually.

Alternatively, or in addition to, the above, it should be appreciated that a network system may also transmit a single message as disclosed herein to the wireless transmission device, such as a UE or ambient IoT device, over a wireless radio interface. Such a message would not require a prior authentication or security context to be established between the network and wireless transmission device (which in that case would be a wireless receiving device only or a combined wireless transmission/receiving device as signal messages would be sent in both uplink and downlink directions; to include these options, the term wireless device is used in the remainder of this paragraph). The network system may comprise a network element configured to transmit the single message, for example a wireless transmission network node or a core network node, and may comprise an authentication system having access to the long-term key of the wireless device. If the wireless device is an ambient IoT device, it should be ensured that the wireless device is sufficiently powered, for example by the single message from the network element, to process the single message. In this example of the network element transmitting the single message, the wireless device would be configured to authenticate the network element. The single message may contain the device identifier in the clear, so that wireless devices can easily verify whether the single message is addressed to them. The wireless device may have access to the same nonce as used by the network to derive the derived key from the long-term key. One or more nonces may be provided to the wireless device prior to receiving the single message. The single message may contain information indicating the nonce in the clear, which is particularly useful in case the wireless device has access to multiple nonces. In an alternative, the single message may contain the nonce, i.e. the used nonce itself, in the clear. Authentication would in this case comprise that the wireless device verifies that the network element has (direct or indirect) access to the long-term key of the wireless device, by the wireless device decrypting the single message using the derived key derived from the long-term key in the wireless device. For this purpose, the single message again contains encrypted information, for example an encrypted version of the device identifier, an encrypted version of the nonce used, or other encrypted data that can be verified after decryption by the wireless device to correspond to known data. Other examples of such wireless device and transmitting network element can be modified accordingly by reversing the roles of wireless transmitting device and the authentication system in the embodiments disclosed in the present application. In such examples where the single message contains data, this may be data from the client system (and may alternatively or additionally be encrypted by a client key) or the network to the wireless device, such as instructions, new nonce information etc. In such examples, the single message may even be sent in the power signal (for example as disclosed in application EP22210972.0).

Thus an aspect of the disclosure relates to a network system having access to a long-term key associated with a wireless device and having access to one or more nonces. The network system may be configured to perform a transmission to the wireless device. The wireless device is configured to wirelessly receive the transmission and has a device identifier. The transmission may be configured to be authenticated in the wireless device without requiring a bidirectional connection between the wireless device and the network system. The network system may be configured to access the long-term key of the wireless device based on a device identifier or a further device identifier. The network system may generate a derived key from the long-term key and a nonce of the one or more nonces. The network system may transmit the transmission consisting of a single message containing at least the device identifier encrypted with the derived key for authentication in the wireless device.

A further aspect of the disclosure relates to a method in a wireless transmission device for performing transmission to a network comprising at least a wireless receiving node configured to wirelessly receive the transmission and a further network system behind the wireless receiving node in the network. The transmission is configured to be authenticated in the network without requiring a bidirectional connection between the wireless transmission device and the further network node in the network. The wireless transmission device may contain a long-term key, one or more nonces and a device identifier. The method includes the step of generating a derived key from the long-term key and a nonce of the one or more nonces, and transmitting a single message containing at least the device identifier encrypted with the derived key for authentication in the network.

The disclosure also pertains to a computer program comprising one or more software code portions for performing such a method in a wireless transmission device when executed by a processor in such a device.

A still further aspect of the disclosure involves a method in an authentication system having access to a long-term key of a wireless transmission device and a nonce used by the wireless transmission device to derive a derived key. The method may include the steps of receiving a single message from the wireless transmission device containing a device identifier of the wireless transmission device encrypted with the derived key and accessing the long-term key and the nonce based on a device identifier of the wireless transmission device accessible by the authentication system to derive the derived key. The method may further involve the step of authenticating the wireless transmission device by decrypting the encrypted device identifier from the single message using the derived key.

The disclosure also pertains to a computer program comprising one or more software code portions for performing such a method in an authentication system when executed by a processor in such a system.

Yet another aspect of the disclosure relates to a system comprising a wireless transmission device and an authentication system as disclosed herein.

As will be appreciated by one skilled in the art, aspects of the present invention may be embodied as a system, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the person's computer, partly on the person's computer, as a stand-alone software package, partly on the person's computer and partly on a remote computer, or entirely on the remote computer or server. In the latter scenario, the remote computer may be connected to the person's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

Moreover, a computer program for carrying out the methods described herein, as well as a non-transitory computer readable storage-medium storing the computer program are provided.

Elements and aspects discussed for or in relation with a particular embodiment may be suitably combined with elements and aspects of other embodiments, unless explicitly stated otherwise. Embodiments of the present invention will be further illustrated with reference to the attached drawings, which schematically will show embodiments according to the invention. It will be understood that the present invention is not in any way restricted to these specific embodiments.

### BRIEF DESCRIPTION OF THE DRAWINGS

Aspects of the invention will be explained in greater detail by reference to exemplary embodiments shown in the drawings, in which:

FIG. 1 is a schematic illustration of two use cases, wherein a wireless transmission device transmits a single message using fast authentication;

FIGS. 2A and 2B are schematic illustrations of a use case wherein the wireless transmission device is an ambient IoT device and transmits a single message using fast authentication and a schematic structure of an ambient IoT device;

FIGS. 3A-3C are schematic diagrams showing various examples of single messages configured for fast authentication;

FIG. 4 is a time diagram showing a basic embodiment for fast authentication by transmitting a single message to a network;

FIG. 5 is a time diagram showing another embodiment for fast authentication by transmitting a single message to a network; and

FIG. 6 depicts an example of a processing system according to an embodiment of a wireless transmission device or an authentication system or a part thereof.

### DETAILED DESCRIPTION OF THE DRAWINGS

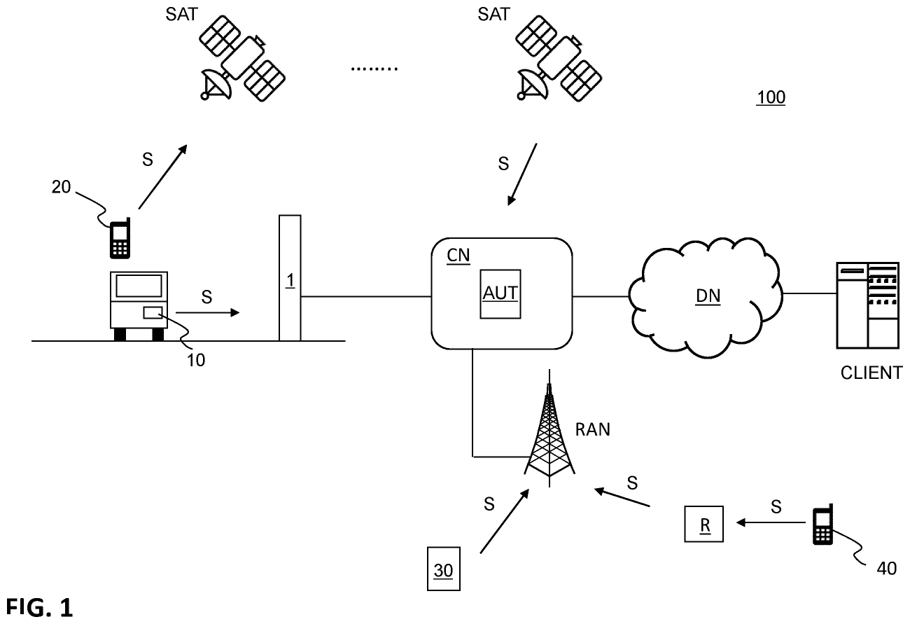

FIG. 1 is a schematic illustration of a system 100 comprising a wireless transmission device 10, 20, 30, 40 configured for transmitting a single message S for fast authentication. FIG. 1 depicts a number of use cases for the single message in one figure, but it should be appreciated that these use cases are not necessarily applied in one system 100 or with one authentication system AUT.

Wireless transmission device 10 is configured for vehicle-to-anything, V2X, communication, for example with a roadside infrastructure element 1. Such communications may include small data amounts, such as vehicle status information, payment information, etc. Roadside infrastructure element 1 is connected to a telecommunications core network CN that contains an authentication system AUT configured for fast authentication of wireless transmission devices 10. The core network is connected to a data network DN for providing data to a client system CLIENT.

In cases which involve high mobility of the wireless transmission device 10, there might not always be an end-to-end connection between device 10 and the core network CN. For example, wireless transmission device 10 might be connected to the core network CN through different intermediate nodes at each instance of time. A problem arises because wireless transmission device 10 might be connected to one intermediate node only for a short time. When the device go through a regular authentication procedure, it may have lost connection to the intermediate node before such a procedure is completed.

In the same FIG. 1, wireless transmission device 20 (for example a user equipment, UE, as standardized in 3GPP) may want to transmit a single message S to a (non-geostationary) satellite SAT. Such a single message may contain a small data amount (e.g. a text message). For example, the text message may have to be delivered to another device wirelessly connected to a radio access network, RAN, of the operator. At the point in time that wireless transmission device 20 wants to send the data, the satellite SAT is not connected to the telecommunications core network of the network operator. When the satellite SAT has moved and can connect to the network, it might not be able to connect to the wireless transmission device 20 anymore.

If the wireless transmission device 20 has to authenticate using regular methods and establish a secure association to send messages, it needs a bidirectional end-to-end connection with the network CN. In this case, a problem might arise because there might not always be an end-to-end connection between the wireless transmission device 20 and the core network, because satellite SAT may not be connected simultaneously to the wireless transmission device 20 and the network CN.

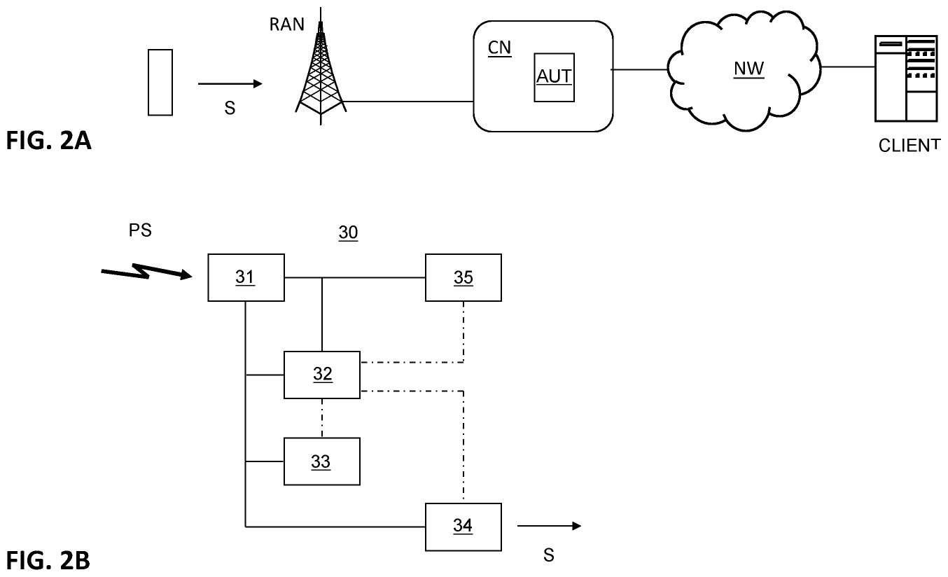

Wireless transmission device 30 amounts to an ambient IoT device and will be described in further detail with reference to FIGS. 2A and 2B.

Wireless transmission device 40 comprises a user equipment wirelessly connected to a relay node R, which may forward single message S from the device to the network at a later point in time, for example in case a connection to the network is absent when receiving the single message. This allows the wireless transmission device 40 to transmit the single message S without a need to wait for the connection of the relay node to the network to be (re)established.

It is noted that a network node, like a core network node (for example, authentication system AUT, or a system for Access and Mobility Function (AMF), Unified Data Management (UDM) or Authentication Server Function (AUSF) function) or a base station of the RAN or a satellite SAT, may likewise transmit a single message as disclosed in this patent application to wireless transmission nodes 10, 20, 30, 40. This single message is not shown in FIG. 1.

FIG. 2A is a schematic illustration of a wireless transmission device 30 transmitting a single message S configured for fast authentication to the network over a radio access network, RAN, of a telecommunications network. The telecommunications network further contains a core network CN comprising a further network node, represented as authentication system AUT. The further network node is a node behind the wireless receiving node, that may have a wireless or wired connection to the wireless receiving node, such as base station, a satellite, a system performing a control plane function in a 5G or further generation network, such as an Access and Mobility Function, AMF, an Authentication Server function, AUSF, a Unified Data Management, UDM, function, or a dedicated authentication function in a telecommunications network.

In one embodiment, the telecommunications network may be a 4G, 5G or 6G network as standardized by 3GPP, or a combination thereof. For example, the base station of the telecommunications network may be a 4G base station (an eNodeB, for example) or a 5G base station (a gNb, for example), while further components of, for example, the core network are standardized in 5G or 6G. In some embodiments, wireless transmission device 30 is configured to communicate wirelessly with the telecommunications network using a single message S. Communication may also be directly to another device (not shown). In other embodiments, the telecommunications network may be a WiFi network, such as a WiFi6 or WiFi7 network, and the wireless transmission device may transmit the single message S on a WiFi radio channel or transmit directly to another device using WiFi Direct.

Wireless transmission device 30 may be an ambient IoT device. Essentially, the ambient IoT device 30 is a battery-less device with limited, if any, energy storage capability (one or more capacitors may be included) wherein the energy is provided through the harvesting of radio waves, light, motion, heat or any other power source that could be suitable. The ambient IoT device 30 is not capable of storing any significant power provided to it in the power signal PS, which may be of limited duration, and uses the supplied power almost immediately to complete its desired actions. Since such ambient IoT devices harvest power exclusively from external stimuli, such ambient IoT device cannot perform lengthy procedures to authenticate and establish a bidirectional association to send messages and therefore benefit from fast authentication as disclosed herein.

An embodiment for an ambient IoT device is schematically illustrated in FIG. 2B. FIG. 2B is a schematic illustration of an ambient IoT device 30 configured to receive a power signal PS. The ambient IoT device 30 comprises a power harvesting part 31, a processing part 32 and a storage part 33 configured to store, at least, a device identifier. Storage part 33 may comprise several forms of memory, including secured memory for, for example, storing encryption information.

The ambient IoT device 30 may comprise at least one of a communication part 34 and, optionally, at least one sensor 35 (or a connector therefore). It should be appreciated that ambient IoT device 30 may comprise a plurality of sensors 35 or connectors therefore. Examples of sensors include a location sensor, a temperature sensor, a humidity sensor, a light sensor, a pressure sensor, a motion sensor etc. A time stamp generator may also be a function available in the device, to store time stamps with the stored data.

It is appreciated that ambient IoT devices 30 may comprise more or fewer parts.

The ambient IoT device 30 is configured to harvest power from a power signal PS and to operate at least the processing part 32 and communication part 34. Power supply lines to these parts are indicated by the solid lines in FIG. 2B. Power signal PS may come from any external power source, such as from a base station of a radio access network RAN, shown in FIG. 2A or from a separate power source triggering the ambient IoT device 30 with a radio wave power source. Alternative sources may be used, however, such as pressure from manually pressing a button or from a light source.

The processing part 32 is configured to execute one or more processing steps, based for example on computer code obtained from storage part 33. Signal lines for such processing and communication with other parts, including communication part 34 and sensor(s) 3 are indicated by the dashed-dotted lines in FIG. 2B.

The use cases as depicted in FIGS. 1 and 2A, 2B benefit from a fast authentication as disclosed herein, because of lacking end-to-end connectivity to an authentication entity, insufficient transmission time, or power restrictions for the transmitting device. It is to be appreciated that other considerations may apply for using the fast authentication message as disclosed herein. One example would be that the amount of data to be transmitted is small so that it would be inefficient to perform an extended authentication procedure and establish a security context. Such procedure would result in a higher overhead than justified for actual data to be exchanged between the wireless device and network.

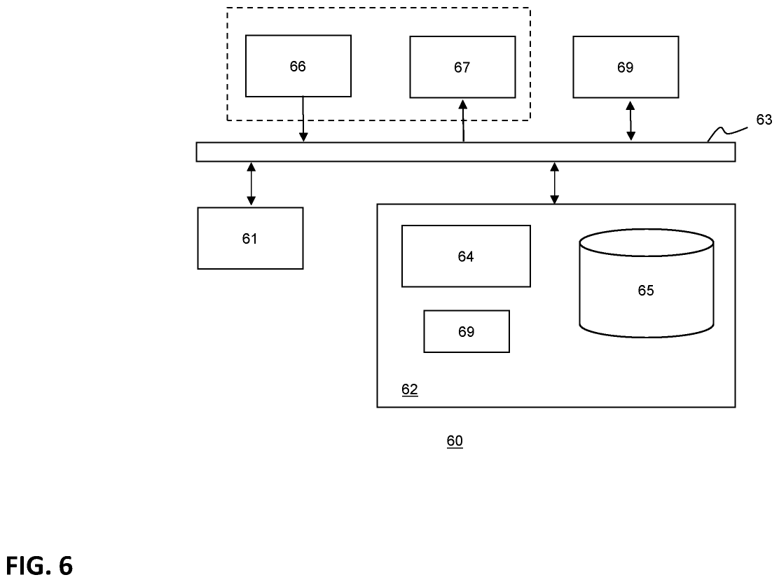

It should be appreciated that also wireless transmission devices 10, 20, 40 as depicted in FIG. 1 may have one or more of the parts described above for the ambient IoT device 30, and shown in more general form in FIG. 6, to perform the functionalities disclosed herein. However, the remaining description will focus on a wireless transmission device comprising an ambient IoT device 30.

The wireless transmission device 30 is configured to perform a transmission to a network comprising at least one wireless receiving node, for example a base station of a RAN or an infrastructure element 1 as depicted in FIG. 1 configured to wirelessly receive the transmission. The wireless transmission device 30 may have or need to establish an RRC connection with the wireless receiving node. A further network system, such as an entity in the core network CN, such as authentication system AUT is behind, i.e. in the uplink direction of the wireless transmission device. The transmission is configured to be authenticated in the network without requiring a bidirectional connection or channel between the wireless transmission device 30 and the further network node in the network. Therefore, the wireless transmission device 30 may contain a long-term key K-LT, one or more nonces, Nonce, or information representing the Nonce, and a device identifier ID_{DEV}. One or more of these may, for example, be stored in storage part 33 of the wireless transmission device 30. The wireless transmission device 30 may be configured to generate a derived key K-D from the long-term key K-LT and a nonce, Nonce, of the one or more nonces. The transmission comprises of a single message S containing at least the device identifier ID_{DEV} encrypted with the derived key K-D for authentication in the network.

Examples of such device identifiers may include identifiers as defined in 3GPP, such as IMSI, SUPI, etc, or more generally, identifiers that are associated with a subscription (and as part of that, a long-term key K-LT. Other device identifiers may be applicable as well, such as application level identifiers (e.g. IMEI) or other identifiers, such as a car identifier for wireless transmission device 10 (e.g. a VIN number) or Electronic Product Code (EPC), for logistics.

Authentication system AUT is provided in a network having access to a long-term key K-LT of a wireless transmission device 30 and a nonce, Nonce, used by the wireless transmission device 30 to derive a derived key K-D. The authentication system AUT is configured to receive a single message S from the wireless transmission device 30 containing a device identifier ID_{DEV} of the wireless transmission device 30 encrypted with the derived key K-D. The authentication system AUT is further configured to access the long-term key K-LT and nonce based on a device identifier ID_{DEV} of the wireless transmission device 30 accessible by the authentication system to derive the derived key K-D and to authenticate the wireless transmission device 30 by decrypting the encrypted device identifier ID_{DEV} from the single message S using the derived key K-D. The authentication system AUT does not require a bidirectional connection with the wireless transmission device 30. The authentication system may determine that device identifier ID_{DEV} of the wireless transmission device 30 is authentic for example by comparing the decrypted device identifier ID_{DEV} and the device identifier corresponding to the long-term key accessed by the authentication system AUT. The authentication system does not require a bidirectional connection with the wireless transmission device 30.

In order to enable the wireless transmission device 30 and the authentication system AUT to derive the same derived key, the nonce used at both sides should be the same. This can be achieved in a number of ways. Both sides may store a nonce or set of nonces for the device and signaling of the nonce or information representing the nonce is performed prior to or with the transmission of the single message S. Information representing the nonce may include an identifier of the nonce (instead of the nonce itself) or an input parameter used to generate the nonce at one or both sides. The nonce, or information representing the nonce, can also be sent in the clear as long as it is not reasonably feasible to recreate the long-term key from the nonce and the derived key (for example when an irreversible function is used to derive the derived key from the long-term key and the nonce). An identifier of the nonce, or a parameter that can be used to generate the nonce (possibly combined with the previously used nonce) can provide a measure of obfuscating the nonce, but also can reduce the number of bits that need to be sent. An identifier for a nonce in a set of nonces, e.g. an ordered list of nonces, is shorter than the nonce itself.

The wireless transmission device 30 generates, and authentication system AUT processes a single message S containing sufficient information to authenticate the wireless transmission device 30 or the single message S that it sends. The single message S does not require an authentication and association procedure with multiple steps as will be explained below in more detail. The wireless transmission device 30 and authentication system AUT provide for a lightweight authentication solution for situations wherein the wireless transmission device 30 is power limited severely or where a bidirectional connection or channel is not guaranteed or required.

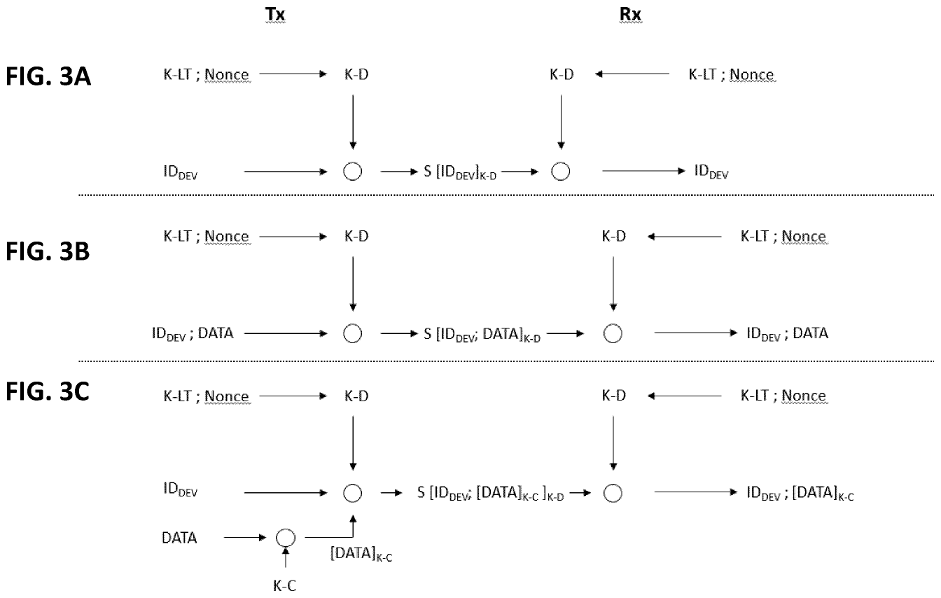

FIGS. 3A-FIG. 3C are schematic diagrams showing various examples of single messages S configured for fast authentication. The left-hand side is the transmission side Tx, i.e. operations at the wireless transmission device. The right-hand side is the receiving side, Rx, i.e. the network side. Alternatively, or in addition, not shown, the network side and wireless transmission device can be reversed (network side as transmission side Tx and wireless transmission device as receiving side Rx).

FIG. 3A assumes the wireless transmission device 30 contains a long-term key K-LT and a Nonce. The nonce can also be generated from a random seed generator, implemented, for example, in processing part 22 of ambient IoT device 30, as long as both the wireless transmission device 30 and the network use the same set of inputs to such a generator to get the same nonces. The wireless transmission device 30 derives the derived key K-D from K-LT and Nonce. The derived key K-D is used for encrypting the device identifier ID_{DEV}.

Below and in the figures, a information element is shown as encrypted using the subscript with a key. For example, [ID_{DEV}]_{K-D} indicates encryption of ID_{DEV} with a security function using K-D as the encryption key. Various security functions, known by the skilled person, can be used here. Some security functions may use further nonces, for example Nonce2, for encryption. This Nonce2 may be sent along with the single message in similar ways as for Nonce (e.g. nonce in clear, identifier of nonce, parameter for derivation of nonce).

In the example of FIG. 3A, the single message S only contains the device identifier ID_{DEV}. This may be sufficient for an operator of client system CLIENT when searching for the presence of a particular transmission device 30. For an ambient IoT device 30, the transmission of single message S may have been triggered from a power pulse PS, for example transmitted from a base station of the RAN.

At the network side, for example in authentication system AUT, the network is configured to access the long-term key K-LT and nonce, Nonce, used by the wireless transmission device 30 for deriving derived key K-D.

One way how the network may know the device that transmitted the message is e.g. that the single message S comes in via a particular channel or link (e.g. on lower layer protocol, such as RRC signaling), which the network can associate with a device identifier. In this manner, the network side may also derive the derived key K-D and, hence, be able to decrypt the encrypted device identifier ID_{DEV}. The authentication system may determine that device identifier ID_{DEV} of the wireless transmission device 30 is authentic for example by comparing the decrypted device identifier ID_{DEV} and the device identifier corresponding to the long-term key accessed by the authentication system AUT.

Another way to obtain the device identity to access the long-term key K-LT and nonce, Nonce, is that the device sends a device identifier in the clear, for example a temporary device identifier (such as TMSI), from which the network can derive the device identifier ID_{DEV} or a secure device ID (such as SUCI).

The single message S contains the device identifier ID_{DEV} in encrypted form to enable authentication of the wireless transmission device or its message. The device identifier ID_{DEV} may also be of interest as data beyond the purpose of authentication, for example when the mere presence of the device is to be verified as described above. However, in one embodiment, the single message S may contain a further, small amount of data, DATA, as shown in FIG. 3B. Such data may, without limitation, comprise sensor data gathered by sensors 35 of, or connected to, the wireless transmission device 30, status information of the device, or be data stored in the device 30, for example in storage part 33. The data may be encrypted with the derived key K-D to protect the data during transmission to the network, as shown in FIG. 3B. In this manner, the network may both authenticate the wireless transmission device and receive data from this device.

The data may, in addition or alternatively, be encrypted with a client key K-C, available to the wireless transmission device 30 and a client system CLIENT, to protect the data in the telecommunications network until the data arrives at the client system CLIENT. This embodiment is depicted in FIG. 3C.

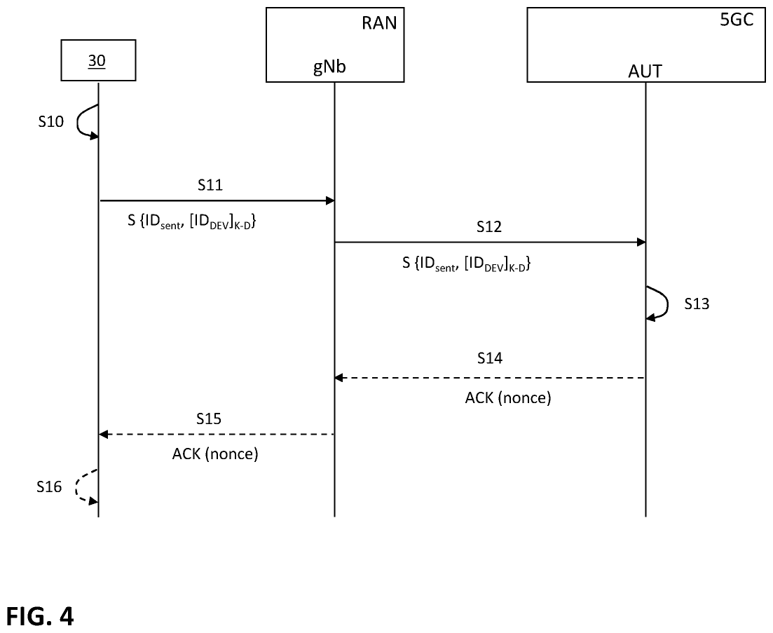

FIG. 4 is a time diagram showing a basic embodiment for fast authentication of a wireless transmission device 30 by transmitting a single message S to a network comprising a radio access network RAN having a plurality of base stations gNb and a 5G core network 5GC. Such base stations and 5GC are generally known by the skilled person and standardized by 3GPP.

Wireless transmission device 30 is assumed to be pre-provisioned with a long-term key K-LT and a set of nonces 1 . . . n. As described with reference to FIG. 3A, wireless transmission device 30 may, upon being triggered to perform a transmission, derive in step S10 a derived key K-D from the long-term key K-LT and a particular nonce, Nonce, from the set. In addition to the device identifier ID_{DEV} for authentication, the single message to be transmitted may also contain further information, for example information IDₛₑₙₜ associated with the device.

For example, the information representing the device identifier may be a temporary identifier or some other identifier that may be used in the authentication system AUT to trace the long-term key K-T and the nonce used for deriving the derived key K-D in that system AUT.

In step S11, wireless transmission device 30 transmits single message S as shown in FIG. 4, wherein the information representing the device identifier is left unencrypted.

In step S12, the wireless receiving node gNb forwards the entire single message S to an authentication system AUT in the 5GC. Authentication system AUT uses the information IDₛₑₙₜ representing the wireless transmission device 30 to determine the long-term key K-T and the nonce used for deriving the derived key K-D in the authentication system AUT. The derived key K-D is then used to obtain the device identifier ID_{DEV} for authentication in step S13. The wireless transmission device and/or the single message S are considered authentic when the authentication system AUT determines that the received IDsent is associated with the decrypted IDdev.

Optionally, and only if sufficient power is available at the wireless transmission device 30, if authentication is successful or the message is successfully received, authentication system AUT may enable the 5GC to trigger sending an acknowledgement ACK back to the wireless transmission device 30 in steps S14 and S15. The ACK signal may contain a new nonce or set of nonces, resulting in signal ACK(nonce) for the wireless transmission device 30. Wireless transmission device 30 may store the nonce or set of nonces and/or discard the data from its storage in response to receiving the ACK, step S16.

Depending on the number of nonces in the set of nonces, new nonce information may be provided prior to each single message, or less frequently. An example of the latter is that the set size (and the size of the storage part 23 of the device 30) may provide sufficient nonces for a particular lifetime or purpose, e.g. for a cargo shipment of a box or any container, or for distribution of a product from factory to customer. A new set of nonce information may then be provided prior to the next deployment, e.g. a next shipment or distribution.

An initial parameter for a nonce generator, an initial nonce or initial set of nonces may be provided to the wireless transmission device 30 in the same manner as the new nonce information. Initial nonce information may also be pre-stored in the wireless transmission device 30 prior to deployment, for example in storage par 33.

It is noted that error cases may exist, wherein a reset for the picking or derivation of nonces is desired when authentication is not successful.

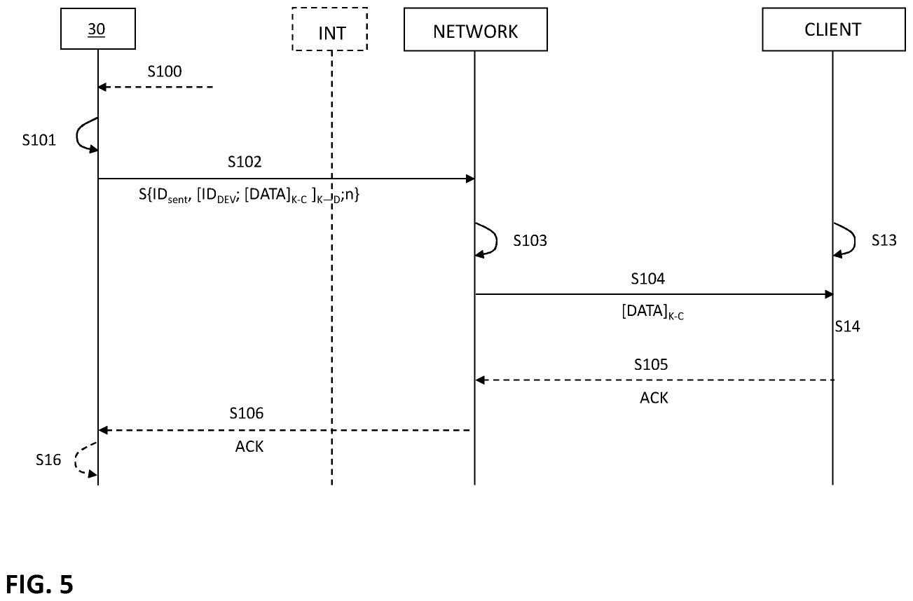

FIG. 5 shows a more detailed example of a use case wherein an ambient IoT device 30 is triggered to transmit a single message S by a power pulse in step S100. The power pulse may be transmitted from or coordinated by the network to which the single message is to be sent, but may also be from a separate power pulse generator (not shown).

In response to this pulse, the ambient IoT device 30 derives a derived key K-D based on the long-term key K-LT and a nonce identified by nonce identifier n. As mentioned above, the nonce can also be generated from a random seed generator as long as both the device 30 and the network use the same set of inputs to such a generator to get the same nonce for deriving the derived key K-D.

The data to be transmitted is encrypted (this step may have been executed prior to receiving the power pulse in step S100, for example when the data was collected) with a client key K-C. Both the device identifier ID_{DEV} and the data encrypted with K-C are then encrypted with K-D. Information representing the nonce (here nonce identifier n) and information identifying the device 30 (IDₛₑₙₜ) are also included in the single message S configured in step S101. The information identifying the device 30 which is to be sent (IDₛₑₙₜ) can be a temporary identifier obtained from the network, such as a TMSI, or obtained using some function which takes the device identifier ID_{DEV} as input. This function may be a public key encryption function that encrypts the device identifier ID_{DEV} with a public key of the network or be a function used to convert SUPI to SUCI as known from 5G networks.

The single message S is transmitted, possibly via an intermediate node INT, to the network comprising an authentication system, in step S102.

In step S103, the network can identify the long-term key K-LT associated with the ambient IoT device 30 based on the information identifying the device IDₛₑₙₜ and the nonce based on nonce identifier n. If the information identifying the device is generated by applying a function, the network may check if IDₛₑₙₜ is valid. The network can derive the derived key K-D from the long-term key K-LT and the nonce associated with the nonce identifier n. In this manner, the device identifier ID_{DEV} can decrypted and the single message S be determined to be authentic. If any of the above steps fail, then the authentication may be considered not successful.

If authentic, the network may transmit the data, that is still encrypted under client key K-C, to the client system CLIENT, in step S104. The client system may, optionally, acknowledge successful receipt of the data to the network in step S105.

The network may, optionally, acknowledge successful receipt of the single message S in the network and/or successful receipt of the data at the client system CLIENT, to the ambient IoT device 30 in step S106. Optionally, the network may send a new set of nonces or information to generate new nonces.

The transmission in step S106 may be a power pulse enabling the ambient IoT device 30 to receive and process the acknowledgment. The power pulse may be a single power pulse having the acknowledgement and/or information representing the new set of nonces modulated therein or the mere presence of the power pulse may be considered as an acknowledgement.

FIG. 6 depicts a block diagram illustrating an exemplary processing system according to a disclosed embodiment, e.g. a wireless transmission device 20, 40, a network system or a network element, or a authentication system AUT as described above for use in a system 100. As shown in FIG. 6, the processing system 60 may include at least one processor 61 coupled to memory elements 62 through a system bus 63. As such, the processing system may store program code within memory elements 62. Further, the processor 61 may execute the program code accessed from the memory elements 62 via a system bus 63. In one aspect, the processing system may be implemented as a computer system that is suitable for storing and/or executing program code. It should be appreciated, however, that the processing system 60 may be implemented in the form of any system including a processor and a memory that is capable of performing the functions described within this specification.

The memory elements 62 may include one or more physical memory devices such as, for example, local memory 64 and one or more bulk storage devices 65. The local memory may refer to random access memory or other non-persistent memory device(s) generally used during actual execution of the program code. A bulk storage device may be implemented as a hard drive or other persistent data storage device. The processing system 60 may also include one or more cache memories (not shown) that provide temporary storage of at least some program code in order to reduce the number of times program code must be retrieved from the bulk storage device 65 during execution.

Input/output (I/O) devices depicted as an input device 66 and an output device 67 optionally can be coupled to the processing system. Examples of input devices may include, but are not limited to, a space access keyboard, a pointing device such as a mouse, or the like. Examples of output devices may include, but are not limited to, a monitor or a display, speakers, or the like. Input and/or output devices may be coupled to the processing system either directly or through intervening I/O controllers.

In an embodiment, the input and the output devices may be implemented as a combined input/output device (illustrated in FIG. 6 with a dashed line surrounding the input device 66 and the output device 67). An example of such a combined device is a touch sensitive display, also sometimes referred to as a “touch screen display” or simply “touch screen” that may be provided with the UE. In such an embodiment, input to the device may be provided by a movement of a physical object, such as e.g. a stylus or a finger of a person, on or near the touch screen display.

A network adapter 68 may also be coupled to the processing system to enable it to become coupled to other systems, computer systems, remote network devices, and/or remote storage devices through intervening private or public networks. The network adapter may comprise a data receiver for receiving data that is transmitted by said systems, devices and/or networks to the processing system 60, and a data transmitter for transmitting data from the processing system 60 to said systems, devices and/or networks. Modems, cable modems, and Ethernet cards are examples of different types of network adapter that may be used with the processing system 60.

As pictured in FIG. 6, the memory elements 62 may store an application 69. In various embodiments, the application 69 may be stored in the local memory 64, the one or more bulk storage devices 65, or apart from the local memory and the bulk storage devices. It should be appreciated that the processing system 60 may further execute an operating system (not shown in FIG. 6) that can facilitate execution of the application 69. The application 69, being implemented in the form of executable program code, can be executed by the processing system 60, e.g., by the processor 61. Responsive to executing the application, the processing system 60 may be configured to perform one or more operations or method steps described herein.

In one aspect of the present invention, one or more components of the base station selection support system and/or user device for use with such a base station selection support system. as disclosed herein may represent processing system 60 as described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 61 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration but is not intended to be exhaustive or limited to the implementations in the form disclosed. Many modifications and variations will be apparent to those of ordinary skill in the art without departing from the scope of the claims. The embodiments were chosen and described in order to best explain the principles and some practical applications of the present invention, and to enable others of ordinary skill in the art to understand the present invention for various embodiments with various modifications as are suited to the particular use contemplated.

1. A wireless transmission device configured to perform a transmission to a network comprising at least a wireless receiving node configured to wirelessly receive the transmission and a further network system behind the wireless receiving node in the network, wherein the transmission is configured to be authenticated in the network without requiring a bidirectional connection between the wireless transmission device and the further network node in the network, wherein the wireless transmission device contains a long-term key, one or more nonces and a device identifier,
wherein the wireless transmission device is configured to generate a derived key from the long-term key and a nonce of the one or more nonces, and
wherein the transmission consists of a single message containing at least the device identifier encrypted with the derived key for authentication in the network.

2. The wireless transmission device according to claim 1, wherein the single message further contains data gathered by or stored in the device, optionally encrypted with at least one of the derived key and a client key, stored in the wireless transmission device.

3. The wireless transmission device according to claim 1, wherein the single message further contains information representing at least one of:
an identifier associated with the wireless transmission device;
the nonce of the one or more nonces, used to generate the derived key.

4. The wireless transmission device according to claim 1, wherein the device is an ambient IoT device configured to harvest power from an ambient power source, such as electromagnetic waves (radio waves, light), motion, heat, etc.

5. The wireless transmission device according to claim 4, wherein the device comprises at least a power harvesting part configured to harvest power from a power signal, such as a radio signal, and a communication part configured for being powered by the power signal and for wireless transmission of the single message to the wireless receiving node during powering by the power signal.

6. The wireless transmission device according to claim 4, wherein the wireless transmission device is configured to harvest the power from a single power pulse.

7. The wireless transmission device according to claim 1, wherein the device comprises a receiver for receiving data and/or instructions from the network, including at least one of:
a signal representing an acknowledgement of successful authentication of the wireless transmission device in the network;
new nonce information, wherein the new nonce information is optionally interpreted in the wireless transmission device as an acknowledgement of successful authentication of the wireless transmission device in the network.

8. The wireless transmission device according to claim 7, wherein the wireless transmission device is configured to harvest power from the signal containing the data and/or instructions from the network.

9. The wireless transmission device according to claim 1, wherein the wireless transmission device comprises a storing part storing data and wherein the wireless transmission device is configured to transmit multiple single messages, each single message comprising at least the device identifier encrypted with the derived key and the data or part of the data stored in the storing part.

10. An authentication system for use in a network, the authentication system having access to a long-term key of a wireless transmission device and a nonce used by the wireless transmission device to derive a derived key, wherein the authentication system is configured:
to receive a single message from the wireless transmission device containing a device identifier of the wireless transmission device encrypted with the derived key,
to access the long-term key and the nonce based on a device identifier of the wireless transmission device accessible by the authentication system to derive the derived key, and
to authenticate the wireless transmission device by decrypting the encrypted device identifier from the single message using the derived key.

11. The authentication system according to claim 10, wherein the single message further contains data, optionally encrypted by at least one of the derived key and a client key, wherein the authentication system is configured to enable transmission of the single message encrypted with the client key, if applied, to a client system.

12. The authentication system according to claim 10, wherein the authentication system is further configured to at least one of:
use information representing an identifier of the wireless transmission device in the single message from the wireless transmission device to access the long-term key and optionally, the nonce to derive the derived key;
use information representing a nonce in the single message from the wireless transmission device to derive the derived key together with at least the long-term key.

13. The authentication system according to claim 10, wherein the network system is configured, in response to authentication of the wireless transmission device, to transmit at least one of:
a signal representing an acknowledgement of successful authentication of the wireless transmission device in the network;
new nonce information, wherein the new nonce information is optionally interpreted in the wireless transmission device as an acknowledgement of successful authentication of the wireless transmission device in the network.

14. The authentication system according to claim 13, wherein the authentication system is configured to enable transmission of at least one of the signal representing an acknowledgement of successful authentication and the new nonce information with sufficient power to power the wireless transmission device from which the single message was authenticated.

15. A network system having access to a long-term key associated with a wireless device and having access to one or more nonces, wherein the network system is configured to perform a transmission to the wireless device, the wireless device configured to wirelessly receive the transmission and having a device identifier, wherein the transmission is configured to be authenticated in the wireless device without requiring a bidirectional connection between the wireless device and the network system, wherein the network system is configured to:
access the long-term key of the wireless device based on a device identifier or a further device identifier;
generate a derived key from the long-term key and a nonce of the one or more nonces; and
transmit the transmission consisting of a single message containing at least the device identifier encrypted with the derived key for authentication in the wireless device.
